(19) United States
(12) Patent Application Publication
(10) Pub. No.: US 2005/0154760 A1
(43) Pub. Date: Jul. 14, 2005

(54) Capturing portions of an electronic document

(75) Inventors: Dharmesh N. Bhakta, Austin, TX (US); Jeeha Kim, Austin, TX (US); Trung Q. Ly, Austin, TX (US); Juan F. Obas, Austin, TX (US); Lakshmi N. Potluri, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/755,817

(22) Filed: Jan. 12, 2004

(51) Int. Cl. G06F 17/00

(52) U.S. Cl. 707/104.1

(57) ABSTRACT

The present invention provides a method and apparatus for capturing portions of an electronic document. The method includes activating a capture mode based on a user input, selecting a portion of an electronic document in response to activating the capture mode, and receiving the selected portion of the electronic document in response to selecting the portion of the electronic document. The method also includes providing the selected portion of the electronic document in a predetermined format.

### BACKGROUND OF THE INVENTION

1. Field of the Invention

This invention relates generally to electronic documents, and, more particularly, to capturing portions of an electronic document.

2. Description of the Related Art

The audience for electronically published documents, such as on-line articles and e-books, has increased dramatically in the past few years and is expected to continue to rise. For example, e-books are becoming more popular every day because of their portability and easy access. Electronic documents may be particularly useful for people who need to keep up-to-date in rapidly evolving fields such as information technology. However, there are a number of drawbacks to using electronic documents. For example, an e-book can be several hundred pages long, and a reader may need to search through a large portion of the e-book to relocate an idea or a piece of information that was found in the e-book during a previous reading.

Traditional note-taking, i.e., with a sheet of paper and a pen or pencil, may be used to summarize important ideas and/or gather useful information. However, traditional note-taking may be considered tedious by some people. Taking electronic notes, or saving handwritten notes in electronic form, can also be inefficient, as it may require additional time and effort for data entry and editing. Alternatively, a markup tool may be used to mark up the text of the e-book if the reader has write privileges for the e-book. However, a reader may still spend a large amount of time searching through the e-book to locate the marked up text. The time spent relocating information may be even longer for researchers who were not the original readers of the text. Because these researchers did not insert the mark ups, they may not know where in the e-book the mark ups may be found.

An electronic copy of portions of the electronic document may also be created using the familiar copy-and-paste tools available in virtually all electronic document viewing, creation, and publication software. However, creating a summary document from an e-book using traditional copy-and-paste operations may be a tedious and time-consuming process. For example, in order to transfer a single sentence from a first document to a second document, a reader must first open the first document, select the text of the sentence, “copy” the selected text into a clipboard or buffer using a copy command, open the second document, and finally “paste” the selected text from the clipboard or buffer into the second document using a paste command.

The aforementioned drawbacks to traditional methods of capturing information from electronic documents may be exacerbated when a single reader is trying to capture information from more than one document, when more than one reader is trying to capture information from a single document, or when a team of researchers is trying to summarize a plurality of documents in one or more documents available to the team members. Thus, the efficiency of a reader that is researching a topic using many online articles and/or e-books, or a team that is using the same online articles and/or e-books to research a particular topic, may be reduced. Consequently, traditional methods of capturing information may undermine the original motivation for creating the electronic document, i.e. ease and speed of access to the information in the electronic document.

The present invention is directed to addressing, or at least reducing, the effects of, one or more of the problems set forth above.

### SUMMARY OF THE INVENTION

In one aspect of the instant invention, a method is provided for capturing portions of an electronic document. The method includes activating a capture mode based on a user input, selecting a portion of an electronic document in response to activating the capture mode, and receiving the selected portion of the electronic document in response to selecting the portion of the electronic document. The method also includes providing the selected portion of the electronic document in a predetermined format.

In another aspect of the present invention, an apparatus is provided for capturing portions of an electronic document. The apparatus includes an interface and a control unit communicatively coupled to the interface. The control unit is adapted to activate a capture mode based upon a user input, select a portion of an electronic document in response to activating the capture mode, and receive the selected portion of the electronic document in response to selecting the portion of the electronic document. The control unit is also adapted to provide the selected portion of the electronic document in a predetermined format.

In yet another aspect of the present invention, a method is provided for activating a capture mode and receiving at least one portion of the at least one electronic document in response to the user selecting the at least one portion of the electronic document based on the activated capture mode. The method also includes providing the selected portion of the electronic document in a predetermined format and de-activating the capture mode.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one embodiment of a processor-based device including a capture module, in accordance with the present invention.

FIG. 2 conceptually illustrates one embodiment of a system including a plurality of processor-based devices and a server including a capture module, in accordance with the present invention.

FIG. 3 illustrates one embodiment of a flow diagram of a method of capturing portions of one or more electronic documents, in accordance with the present invention.

FIG. 4 depicts exemplary documents including text that may be captured using the aforementioned method of FIG. 3, in accordance with the present invention.

FIG. 5 shows a stylized block diagram of a processor-based system that may be implemented in FIG. 1 or in the system shown in FIG. 2, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

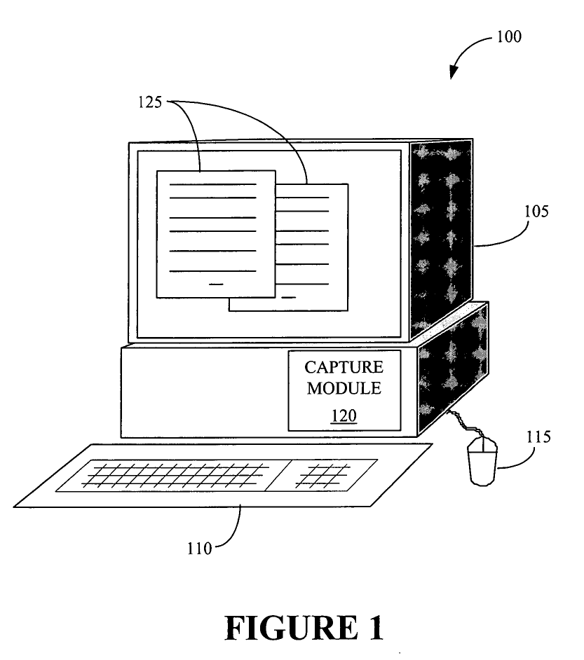

FIG. 1 conceptually illustrates one embodiment of a processor-based device 100 including a display device such as a monitor 105, one or more input devices such as a keyboard 110 and a mouse 115, and a capture module 120. In the illustrated embodiment, referred to hereinafter as a “stand-alone embodiment,” the processor-based device 100 is a desktop personal computer. However, the present invention is not limited to desktop personal computers and, in various alternative embodiments, the processor-based device 100 may be a laptop computer, a personal digital assistant, a mainframe computer, and the like.

The monitor 105 is capable of displaying one or more electronic documents 125 such as electronic articles, online articles, and/or e-books that may be accessed by a user of the processor-based device 100. The electronic documents 125 may include digital information that may be represented on the monitor 105 as text, graphics, video, hyperlinks, and the like. Persons of ordinary skill in the art should appreciate that the digital information included in the electronic documents 125 may be provided in a wide variety of forms. For example, in alternative embodiments, the digital information included in the electronic documents 125 may include other forms of digital information such as embedded files, code fragments, sound clips, animations, and the like. Moreover, the digital information included in the electronic documents 125 may be presented in a variety of formats or types including, but not limited to, XML format, HTML format, PDF format, one or more word processing program formats, rich text format, and the like. For example, the monitor 105 may concurrently display texts from Macromedia®, Lotus® Suite, Microsoft® suite and the web.

Generally, and as described in greater detail below, the capture module 120 allows a user to conveniently and efficiently gather electronic information from one or more of the documents 125. In one embodiment, the user may activate the capture module 120 by providing an input indicating that the user wishes to capture electronic information from one or more of the documents 125. The activated capture module 120 may then capture information that is selected by the user. Additional features may also be provided for organizing the captured information in a variety of desired formats. The capture module 120 illustrated in FIG. 1 is implemented in software, although in other implementations the capture module 120 may also be implemented in hardware or a combination of hardware and software.

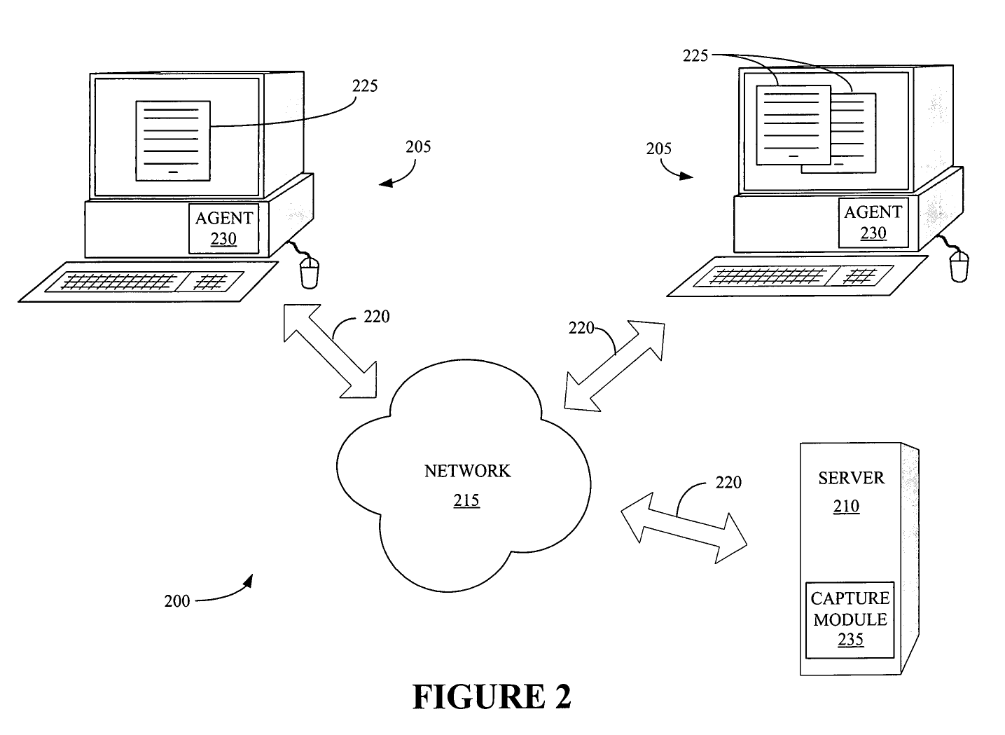

FIG. 2 illustrates an alternative embodiment for practicing one or more embodiments of the present invention. In particular, FIG. 2 conceptually illustrates an embodiment, referred to hereinafter as a “networked embodiment,” that includes a system 200 comprising a plurality of processor-based devices 205 coupled to a server 210 by a network 215. In the illustrated embodiment, a capture module 235 is included in the server 210, which allows users situated at the processor-based devices 205 to capture digital information from one or more of the electronic documents 225. The users of the processor-based device 205 may access the capture module 235 using an agent 230 associated with that processor-based device 205. The agents 230 and the capture module 235 illustrated in FIG. 2 are implemented in software, although in other implementations the agents 230 and the capture module 235 may also be implemented in hardware or a combination of hardware and software.

As discussed above, the processor-based devices 205 may be desktop computers, laptop computers, personal digital assistants, mainframe computers, and the like, as well as any combination of these devices. The server 210, in one embodiment, may be one form of a processor-based device that can be accessed over the network 215.

In the embodiment illustrated in FIG. 2, the processor-based devices 205 and the server 210 are communicatively coupled to the network 215 over one or more communications links 220. In various alternative embodiments, the links 220 may be one or more of infrared links, wireless local area network (LAN) links, wired LAN connections such as Ethernet connections, cellular network links, traces, wires, cables, radiofrequency links, satellite links, and the like. Moreover, any desirable protocol may be used to establish communication between the processor-based devices 205 and the server 210 via the network 215. For example, a transmission control protocol/Internet protocol (TCP/IP), a user datagram protocol (UDP), a file transfer protocol or trivial file transfer protocol (FTP/TFTP), and the like may be used by the network 215, the processor-based devices 205, and the server 210.

As shown in FIG. 2, the processor-based devices 205 may include one or more electronic documents 225 that may be viewed by the users of these devices. The electronic documents 225 may be separate documents, or they may be copies of the same document. Moreover, the electronic documents 225, and/or the copies thereof, may be stored locally on one or more of the processor-based devices 205. Alternatively, the electronic documents 225, and/or the copies thereof, may be stored on the server 210 and accessed remotely by the processor-based devices 205 via the network 215.

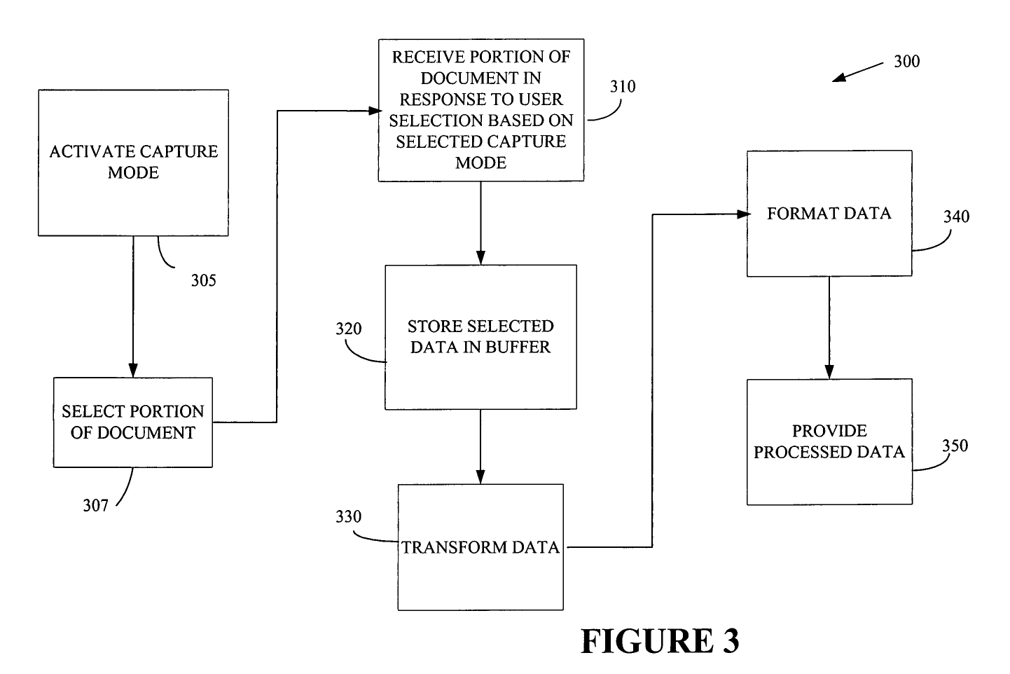

FIG. 3 conceptually illustrates a flow diagram of one embodiment of a method 300 of capturing portions of one or more electronic documents. In the method 300, the capture module 120, 235 allows a user to activate (at 305) a capture mode. In various alternative embodiments, the user may provide different inputs to activate (at 305) the capture mode. In one embodiment, the user may activate (at 305) the capture mode by executing one or more capture modules 120, 235 and/or agents 230. Alternatively, one or more capture modules 120, 235 and/or agents 230 may already be executing, and the user may activate (at 305) the capture mode by pressing a particular key (e.g., a hotkey) on the keyboard 110, using the mouse 115 to click (or double-click) on an icon presented on the display device 105, using a pull-down menu provided by the capture module 120, 235, or taking some other action to indicate that capturing of electronic information is desired.

For the purposes of this discussion, the capture module 120 is considered to be in a “capture mode” once the user indicates that capture of information is desired. In one embodiment, the user may toggle in and out of the “capture mode” by providing an appropriate indication to either activate or deactivate the capture mode. Persons of ordinary skill in the art should also appreciate that any desirable number of users that may activate (at 305) the capture mode and may capture portions of any desirable number of electronic documents. Moreover, the number of users and the number of documents may change after the capture mode has been activated (at 305). For example, a user may open a new document or close an old document after the capture mode has been activated (at 305). For another example, one of a group of users may log-off after the capture mode has been activated (at 305).

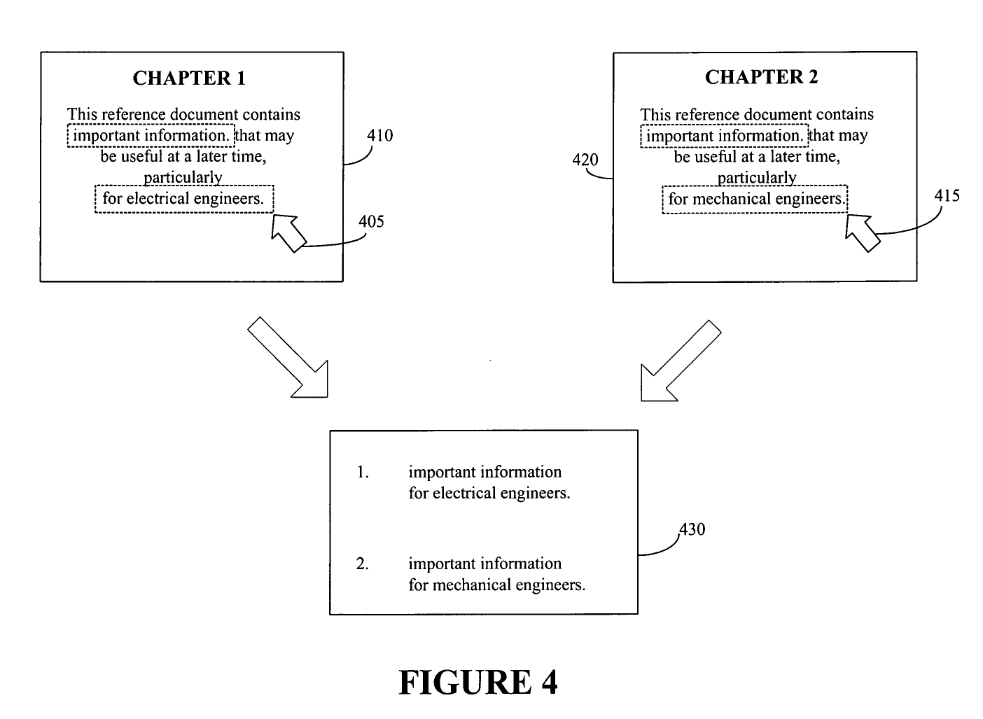

The user may configure the capture mode before, during, or after activating (at 305) the capture mode. In one embodiment, the capture mode may be configured such that the portions of the electronic document to be selected by the user are associated with a delimiter. The delimiter may be a text string indicating a title, a chapter, a caption, a heading, a section, a numeral, a letter, and the like, or any other desirable object, such as an image, an icon, and the like. For example, as shown in FIG. 4, portions of the electronic document 410 (entitled “Chapter 1”) may be associated with the text string, “1.” The delimiters may then be used to organize the captured portions of the document into, for example, an outline, a table of contents, and the like.

The capture mode may also be configured such that the selected portions of the electronic document are organized according to a selected order. For example, the selected portions of the electronic document may be organized according to the sequence in which the user selected each portion, alphabetically, and the like. Alternatively, the capture mode may be configured such that the selected portions of the electronic document are presented in a particular format, such as 12-point Times New Roman. The capture mode may also be configured such that the selected portions of the electronic document are presented in a selected file format, such as HTML, PDF, Word, Word Perfect, and the like.

When in the activated capture mode, the one or more users may then select (at 307) a portion of one or more electronic documents. As illustrated in FIG. 4, a user may use the arrow cursor 405 to select (at 307) the phrase “important information” from the document 410, as indicated by the dashed boxes. For example, the user may select (at 307) a text string by mousing-down at the beginning of the desired string of text, dragging the arrow cursor 405 across the text string, and then mousing-up at the end of the desired text string. However, persons of ordinary skill in the art should appreciate that the present invention is not limited to selecting (at 307) portions of the electronic document using this so-called “click-and-drag” type selection technique. In alternative embodiments, portions of the electronic document may be selected (at 307) in any desirable manner.

When in the capture mode, the user may select (at 307) additional portions of the electronic document. For example, as illustrated in FIG. 4, the phrase “for electrical engineers” may be selected (at 307) from the document 410. Portions of other electronic documents may also be selected (at 307). For example, portions of electronic document 420 (entitled “Chapter 2”) may be selected (at 307) and associated with the text string, “2.” The user may then use the arrow cursor 415 to select (at 307) the phrases “important information” and “for mechanical engineers” from the document 420, as indicated by the dashed boxes.

The capture module 120, 235 receives (at 310) at least one portion of an electronic document in response to a user selecting at least one portion of the electronic document based on the selected capture mode. For example, the portion of the electronic document may be a fragment of XML code including a text string. However, as discussed above, the portion of the electronic document is not limited text and may, in alternative embodiments, include images, hyperlinks, code fragments, embedded files, video clips or segments, sound clips, animations, and the like. Persons of ordinary skill in the art having the benefit of this disclosure will also appreciate that the portion of the electronic document may not be received (at 310) as a single entity or at one time. In various alternative embodiments, a plurality of portions of the electronic document may be received (at 310) at different times in response to the user selecting each of the plurality of portions of the electronic document.

The received selected portion of the electronic document may then be stored (at 320). In one embodiment, the received selected portion of the electronic document may be stored (at 320) in a storage space (e.g., memory, buffer, and the like) as an electronic document in a desired format, such as in XML format. Of course, in other embodiments, a format other than XML may be employed without deviating from the spirit and scope of the invention. For illustrative purposes, it is herein assumed that the received selected portion(s) of the electronic document are saved as an XML document.

In one embodiment, the received selected portion of the electronic document may be converted into an XML format using a predefined document type declaration before it is stored (at 320). As an example, the document type declaration may include definitions for outlines, tables of contents, paragraphs, and the like. The document type declaration for an outline may contain elements such as Title, Main topic, subtopic, details, and the like. If the user indicates that he or she wants to create an outline with the selected portion of the electronic document, the user may be prompted to indicate which part of the outline should contain the selected portion of the electronic document.

The capture module 120, 235 may, in one embodiment, transform (at 330) the stored portion of the electronic document into a desired format. For example, an XML document stored in the file or the memory buffer may be transformed (at 330) into an HTML document, a PDF document, a Word document, a rich text format document, and the like using a utility such as Extensible Style-sheet Language Transformations (XSLT). The stored portion of the electronic document may also be formatted (at 340) into an output file having a desired format. For example, the transformed XML document may be formatted (at 340) using a utility such as Extensible Style-sheet Language Formatting Objects (XSL-FO).

The information processed by the capture module 120, 235 can be provided (at 350) to the user in one of a variety of desirable ways. For example, as shown in FIG. 4, the processed data may be provided (at 350) to a document 430 that is executing in the background of the device 100 (see FIG. 1) or 205 (see FIG. 2). In the embodiment shown in FIG. 4, the document 430 has been transformed (at 330) and formatted (at 340) so that the phrases “important information for electrical engineers” and “important information for mechanical engineers” are displayed next to the strings “1” and “2,” respectively. Referring again to FIG. 3, in an alternative embodiment, the capture module 120, 235 may provide the processed data (at 350) to a file for storage. The user may, in one embodiment, deactivate the capture mode at any desirable time by, for example, providing input indicating that the user would like to deactivate the capture mode or by logging off or turning off the device 100, 205.

In the stand-alone embodiment shown in FIG. 1, the background document or the stored file may be maintained or stored on the processor-based device 100. In the networked embodiment shown in FIG. 2, portions of the background document or the stored file may be maintained or stored on one or more of the processor-based devices 205 or the server 210. In various alternative embodiments, the processed data (at 350) may then be accessed by the user that is creating the output file or other authorized users interested in viewing the output file. For example, the user may view the output file while they are reading, and perhaps selecting, additional portions of the electronic document. For another example, the user may view the output file substantially after they are finished selecting portions of the electronic document. For yet another example, other authorized users, such as other members of a research team, may view the output file at any desirable time.

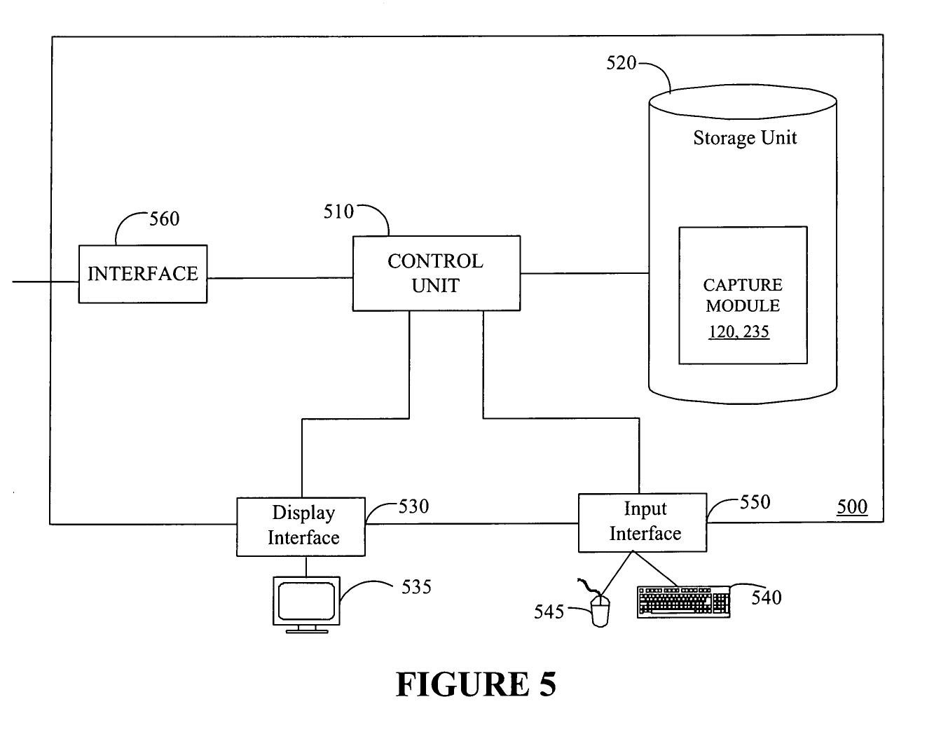

FIG. 5 shows a stylized block diagram of a processor-based device 500, in accordance with one embodiment of the present invention. In one embodiment, such as the stand-alone embodiment shown in FIG. 1, the processor-based device 500 may represent portions of the processor-based device 100. In another embodiment, such as the networked embodiment shown in FIG. 2, the processor-based device 500 may represent portions of the processor-based devices 205 and/or the server 210. The device 500, depending on the particular implementation, is configured with the appropriate software configuration, including with the capture module 120 of FIG. 2, if the device 500 is implemented as the device 205 of FIG. 1 or with the capture module 235, if the device 500 is employed in the system 200 of FIG. 2.

The device 500 comprises a control unit 510, which in one embodiment may be a processor that is communicatively coupled to a storage unit 520. The software installed in the storage unit 520 may depend on the features to be performed by the device 500. For example, if the device 500 represents one of the processor-based devices 100, 205 then the storage unit 520 may include the capture module 120, the agents 230, or the capture module 235. The capture module 120, the agents 230, or the capture module 235 may be executable by the control unit 510. Although not shown, it should be appreciated that in one embodiment an operating system, such as Windows®, Disk Operating System®, Unix®, OS/2®, Linux®, MAC OS®, or the like, may be stored on the storage unit 520 and be executable by the control unit 510. The storage unit 520 may also include device drivers for the various hardware components of the device 500.

In the illustrated embodiment, the device 500 includes a display interface 530. The device 500 may display information on a display device 535 via the display interface 530. In the illustrated embodiment, a user may input information using an input device, such as a keyboard 540 and/or a mouse 545, through an input interface 550. The control unit 510 is coupled to a network interface 560, which may be adapted to receive, for example, a local area network card. In an alternative embodiment, the network interface 560 may be a Universal Serial Bus interface or an interface for wireless communications. The device 500 communicates with other devices through the network interface 560. Although not shown, associated with the network interface 560 may be a network protocol stack, with one example being a UDP/IP (User Datagram Protocol/Internet Protocol) stack or Transmission Control Protocol/Internet Protocol. In one embodiment, both inbound and outbound packets may be passed through the network interface 560 and the network protocol stack.

It should be appreciated that the block diagram of the device 500 of FIG. 5 is exemplary in nature and that in alternative embodiments, additional, fewer, or different components may be employed without deviating from the spirit and scope of the instant invention. For example, if the device 500 is a computer, it may include additional components such as a north bridge and a south bridge. In other embodiments, the various elements of the device 500 may be interconnected using various buses and controllers. Similarly, depending on the implementation, the device 500 may be constructed with other desirable variations without deviating from the spirit and scope of the present invention.

The various system layers, routines, or modules may be executable control units, such as the control unit 510. The control unit 510 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 510 cause the corresponding system to perform programmed acts.

By implementing one or more embodiments of the present invention, one or more of the following advantages may be realized. A user or a team of researchers may reduce the amount of time required to relocate information in one or more previously-read electronic documents. The present invention may also help readers reduce, or completely avoid, redundant effort when referring back to electronic documents such as online articles and e-books. Furthermore, disabled users could use this information to retrieve information more rapidly and to reference significant portions of the electronic document with less stress and effort.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
activating a capture mode based on a user input;
selecting a portion of an electronic document in response to activating the capture mode;
receiving the selected portion of the electronic document in response to selecting the portion of the electronic document; and
providing the selected portion of the electronic document in a predetermined format.

2. The method of claim 1, wherein activating the capture mode based on the user input comprises executing a capture module.

3. The method of claim 1, wherein receiving the at least one portion of the electronic document comprises receiving a plurality of portions of the electronic document in response to the user selecting each of the plurality of portions of the electronic document based on the selected capture mode.

4. The method of claim 3, wherein providing the selected portion comprises providing the plurality of the selected portions in a predetermined order.

5. The method of claim 4, wherein providing the plurality of selected portions in the predetermined order comprises providing the plurality of the selected portions in a predetermined order based upon at least one of an order in which a plurality of portions are selected and an alphabetical order.

6. The method of claim 1, further comprising associating the at least one of the selected portion with at least one delimiter, and further comprising defining at least one of an outline, a table of contents, a page, and a paragraph based upon a document type declaration.

7. The method of claim 6, wherein associating at least one of the selected portions with the at least one delimiter comprises associating at least one of the selected portions with at least one of a text string, an image, video segment, an audio segment, and an icon.

8. The method of claim 1, wherein providing the selected portion of the electronic document in the predetermined format comprises providing the selected portion of the electronic document in at least one of an XML format, an HTML format, a PDF format, a word processing program format, and a text format.

9. The method of claim 1, wherein providing the selected portion of the electronic document comprises providing the selected portion of the electronic document to at least one of a background electronic document and a stored file.

10. An apparatus, comprising:
an interface; and
a control unit communicatively coupled to the interface and adapted to:
activate a capture mode based upon a user input;
select a portion of an electronic document in response to activating the capture mode;
receive the portion of the electronic document in response to selecting the portion of the electronic document; and
provide the selected portion of the electronic document in a predetermined format.

11. The apparatus of claim 10, further comprising at least one processor-based device adapted to provide the at least one portion of the electronic document in response to the user selecting the at least one portion of the electronic document based on the activated capture mode.

12. The apparatus of claim 10, wherein the control unit is adapted to receive an indication via the interface indicating that the user has activated the capture mode.

13. The apparatus of claim 10, wherein the control unit is adapted to provide the selected portion of the electronic document to a background electronic document.

14. The apparatus of claim 10, wherein the control unit is adapted to associate the selected portion with at least one delimiter.

15. The apparatus of claim 10, wherein the control unit is adapted receive a plurality of portions of the electronic document in response to the user selecting each of the plurality of portions of the electronic document.

16. The apparatus of claim 10, further comprising a storage unit, and wherein the control unit is adapted to provide the selected portion of the electronic document to at least one of the storage unit and the interface in the predetermined format.

17. A method, comprising:
activating a capture mode;
receiving at least one portion of the at least one electronic document in response to the user selecting the at least one portion of the electronic document based on the activated capture mode;
providing the selected portion of the electronic document in a predetermined format; and
de-activating the capture mode.

18. The system of claim 17, wherein the second processor-based device is a server, and further comprising a network, and wherein the server and the at least one first processor-based device are communicatively coupled via the network.

19. The system of claim 17, wherein the second processor-based device is adapted to provide the at least one portion of the at least one electronic document to a file in the background.

20. The system of claim 17, further comprising a storage unit, and wherein the second processor-based device is adapted to provide the at least one portion of the at least one electronic document to a file stored in the storage unit.
